(19) United States
(12) Patent Application Publication
(10) Pub. No.: US 2016/0211063 A1
(43) Pub. Date: Jul. 21, 2016

(54) REVERSE MAGNETIZATION STRUCTURE OF DC REACTOR AND REVERSE MAGNETIZATION METHOD USING SUPERCONDUCTING BULK THEREOF

(71) Applicant: INDUSTRY-ACA-DEMIC COOPERATION FOUNDATION, YONSEI UNIVERSITY, Seoul (KR)

(72) Inventors: Tae Kuk Ko, Seoul (KR); Seung Je Lee, Gyeonggi-do (KR); Ji Ho Lee, Gyeonggi-do (KR); Hyun Chul Jo, Seoul (KR); Young Jin Hwang, Incheon (KR); Woo Seung Lee, Gyeonggi-do (KR); Seok Ho Nam, Chungcheongbuk-do (KR)

(21) Appl. No.: 14/915,358

(22) PCT Filed: Sep. 4, 2013
(86) PCT No.: PCT/KR2013/007984

§ 371 Date: Feb. 29, 2016

(30) Foreign Application Priority Data
Aug. 30, 2013 (KR) 10-2013-0104286

(51) Int. Cl. H01F 6/06; H01F 27/28

(52) U.S. Cl. CPC H01F 6/06; H01F 27/2876

(57) ABSTRACT

Provided is a reverse magnetization structure of a DC reactor and a reverse magnetization method using a superconducting bulk thereof. The reverse magnetization structure of a DC reactor may comprise an iron-core; a DC reactor coil located on a primary side of the iron-core; and a superconducting bulk located on a secondary side of the iron-core.

This application claims priority from Korean Patent Application No. 10-2013-0104286 filed on Aug. 30, 2013 in the Korean Intellectual Property Office, the disclosure of which is incorporated herein by reference in its entirety.

### BACKGROUND OF THE INVENTION

1. Field of the Invention

The present invention relates to a reverse magnetization structure of a DC reactor and a reverse magnetization method using a superconducting bulk thereof, and more particularly, to a reverse magnetization structure of a DC reactor that performs a reverse magnetization of the DC reactor using a cylindrical superconducting bulk, and a reverse magnetization method using a superconducting bulk thereof.

2. Description of the Related Art

In order to make a coil that emits a large inductance in a power device, the inductance is enhanced by fitting an iron-core to a coil. In particular, in a DC reactor of a current limiter or a fault current controller of the power device application, the core is inserted to reduce the consumption of the superconducting wire. Since there is no change in inductance of a coil using an air-core, i.e., a coil not using an iron-core depending on the current, the current limiting performance of the DC reactor is constant, regardless of the current value.

FIG. 1 is a graph illustrating a relation between the magnetic field and the magnetic flux density of the superconducting coil that does not use the iron-core.

Referring to FIG. 1, since the iron-core is not used, there is a need for a superconducting coil to increase B (magnetic flux density). However, the length of wire increases, which becomes a cause of an increase in cost.

FIG. 2 is a graph illustrating a relation between the magnetic field and the magnetic flux density of the superconducting coil using the iron-core.

Referring to FIG. 2, when using the iron-core, a B-H curve of metal shows the magnetic saturation. Therefore, as the current increases, the current limiting performance of the DC reactor is lowered. That is, in the case of a coil having a core inserted thereto, the core is magnetically saturated, while the current is increased. Thus, as the inductance rapidly decreases and the current value increases, the current limiting performance rapidly decreases.

In order to solve such a problem, a technique for saturating the core by inserting the coil which performs the reverse magnetization of the core, a so-called reverse magnetization bias (RMB) method is used.

FIG. 3 is a diagram illustrating a circuit diagram for performing a conventional reverse magnetization bias (RMB) technique.

In FIG. 3, an amount of use of the superconducting wire may be reduced to about 1/100, by inserting the reverse magnetization coil \hat{2} to perform the reverse magnetization of the DC reactor coil \hat{1}. That is, when using the RMB method, it is possible to significantly reduce the amount of use of the superconducting wire.

FIGS. 4 and 5 are graphs illustrating each of the fault current of the DC reactor that is not subjected to the reverse magnetization and the fault current of the DC reactor subjected to the reverse magnetization.

Referring to FIGS. 4 and 5, in the case of performing the reverse magnetization, it is possible to know that the magnitude of the current significantly decreases. However, in the case of such a RMB method (the reverse magnetization method), since there is a need to allow the current to continuously flow through the reverse magnetization coil that performs the reverse magnetization of the core, another power supply \hat{4} is required. That is, although there is need to apply the current to the reverse magnetization coil, in the case of a large capacity coil which requires a large inductance, there is also a need to apply considerable magnitude of current to the reverse magnetization coil, which requires the continuous operation of the separate power supply. Accordingly, the significant power consumption and cost burden may become issues.

Therefore, there is a need for a new scheme that can replace the role of the reverse magnetization coil, without always applying the current.

### SUMMARY OF THE INVENTION

An aspect of the present invention provides a reverse magnetization structure of a DC reactor that performs the reverse magnetization of the DC reactor, using a cylindrical superconducting bulk that can replace the role of the reverse magnetization (RMB) coil even without applying the current, and a reverse magnetization method using the superconducting bulk thereof.

Further, another aspect of the present invention provides a reverse magnetization structure of the DC reactor that can perform a field trap in a superconducting magnet even without an external magnetic, by replacing the RMB coil with the superconducting bulk and by removing the external magnetic field after trapping the magnetic field by the field cooling, and a reverse magnetization method using the superconducting bulk thereof.

However, aspects of the present invention are not restricted to the one set forth herein. The above and other aspects of the present invention that have not been mentioned will become more apparent to one of ordinary skill in the art to which the present invention pertains by referencing the detailed description of the present invention given below.

### BRIEF DESCRIPTION OF THE DRAWINGS

The above and other aspects and features of the present invention will become more apparent by describing in detail exemplary embodiments thereof with reference to the attached drawings, in which:

FIG. 1 is a graph illustrating a relation between the magnetic field and the magnetic flux density of a superconducting coil that does not use an iron-core;

FIG. 2 is a graph illustrating a relation between the magnetic field and the magnetic flux density of the superconducting coils using the iron-core;

FIG. 3 is a diagram illustrating a circuit diagram for performing a conventional reverse magnetization bias (RMB) technique;

FIGS. 4 and 5 are graphs illustrating each of a fault current of a DC reactor that is not subjected to the reverse magnetization and a fault current of a DC reactor subjected to the reverse magnetization;

FIG. 6 is a diagram illustrating a reverse magnetization structure of the DC reactor according to an embodiment of the present invention;

FIG. 7 is a conceptual diagram for the operation of the reverse magnetization structure of the DC reactor of FIG. 5; and

FIG. 8 is a diagram illustrating a procedure of a reverse magnetization method using a superconducting bulk according to one embodiment of the present invention.

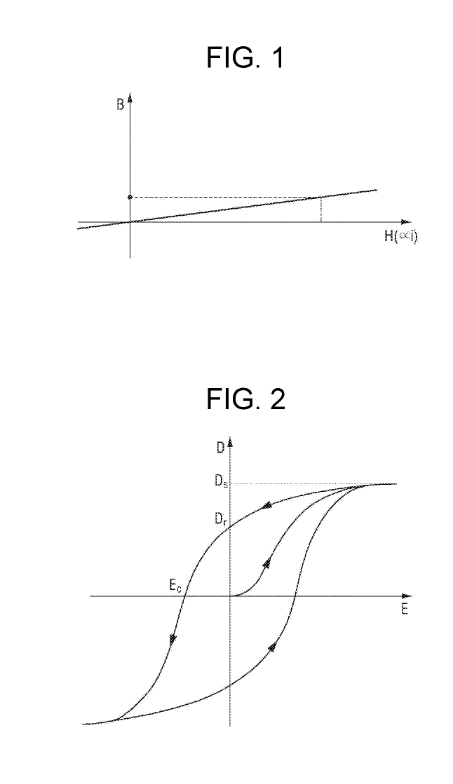

### DETAILED DESCRIPTION OF THE INVENTION

Features of the inventive concept and methods of accomplishing the same may be understood more readily by reference to the following detailed description of preferred embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the inventive concept will only be defined by the appended claims.

In the drawings, the thickness of layers and regions are exaggerated for clarity. As used herein, the term “and/or” includes any and all combinations of one or more of the associated listed items.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Hereinafter, the present invention will be described in more detail with reference to the accompanying drawings.

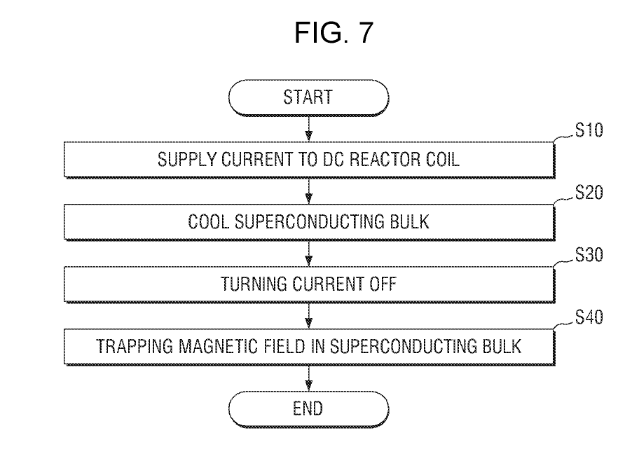

FIG. 6 is a diagram illustrating a reverse magnetization structure of a DC reactor according to an embodiment of the present invention. Further, FIG. 7 is a conceptual diagram for the operation of the reverse magnetization structure of the DC reactor of FIG. 6.

Referring to FIG. 6, the reverse magnetization structure of the DC reactor according to an embodiment of the present invention includes an iron-core 110, a DC reactor coil 120 located on a primary side of the iron-core 110, and a superconducting bulk 130 located on a secondary side of the iron-core 110.

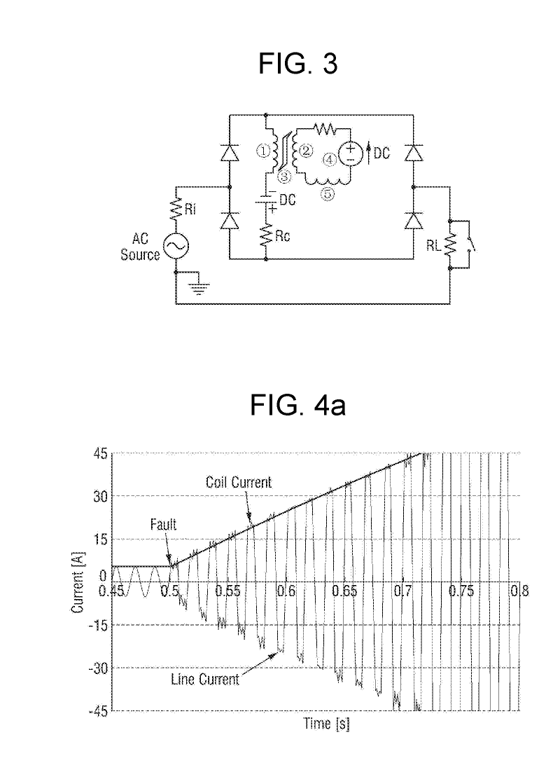

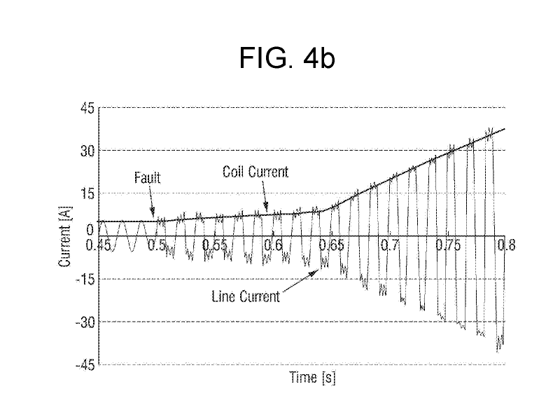

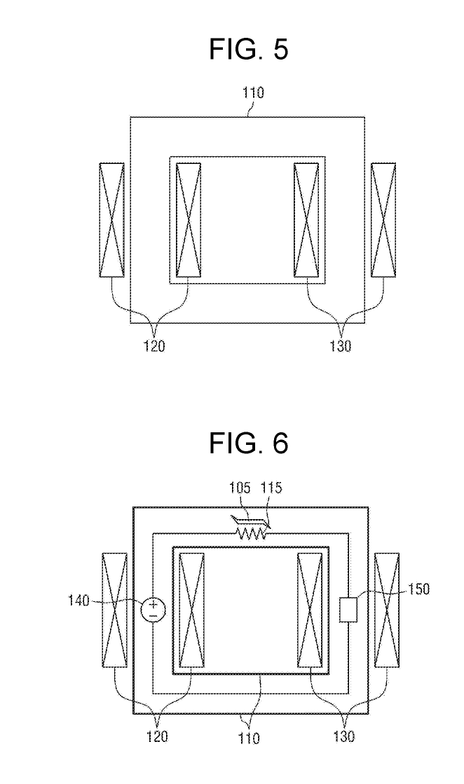

As illustrated in FIG. 6, as compared with FIG. 3, since the reverse magnetization coils for the reverse magnetization of the DC reactor are replaced with the superconducting bulks 130 and a magnetic field of the superconducting bulks 130 is trapped, there is no need for a separate power supply that supplies the current. That is, the conventional reverse magnetization coils are replaced with the superconducting bulks 130, without changing the structure of the iron-core 110.

At this time, the reverse magnetization coils (RMB coils) are replaced with the superconducting bulks 130, and after cooling the magnetic field by the field cooling, by removing the external magnetic field, the field trap can be performed in the superconducting magnet even without an external magnet. In general, when trapping the magnetic field in the superconducting bulk 130, the field cooling is performed by operating the superconducting magnet on the outside. However, when performing the field cooling in a state of applying a DC current to the DC reactor coil 120, the field trap can be performed in the superconducting bulk 130 even without an external magnet.

The superconducting bulk 130 desirably has a cylindrical shape. Since the superconducting bulk 130 replaces the reverse magnetization coil, it is easy to use cylindrical shape in the iron-core 110. Of course, it will be obvious to those skilled in the art that it is possible to use the superconducting bulks 130 of some other shapes other than the cylindrical shape.

Referring to FIG. 7, the reverse magnetization structure of the DC reactor according to an embodiment of the present invention may further include a power supply 140 and a cooler 150, in addition to the iron-core 110, the DC reactor coil 120 and the superconducting bulk 130. In FIG. 7, although the power supply 140 and the cooler 150 are illustrated in the interior of the iron-core 110, this merely conceptually illustrates a configuration in which the power supply 140 is connected to the DC reactor coil 120 and the cooler 150 is connected to the superconducting bulk 130. Since the iron-core 110 has its own load, this is conceptually displayed by a resistance component 115, and an interaction 105 between the DC reactor coil 120 and the superconducting bulk 130 is conceptually illustrated.

The superconducting bulk 130 performs the field cooling for the field trap. Thus, there is a need for a cooler 150 that cools the superconducting bulk 130. In general, although the cooler 150 uses liquid nitrogen (LN2) as a refrigerant, it will be obvious that other materials may be used as a refrigerant.

The power supply 140 supplies current to the DC reactor coil 110. In particular, since a separate power supply is not provided in the superconducting bulk 130, in a state in which the current is applied to the DC reactor coil 110 from the power supply 140, by performing the field cooling, the field trap can be performed in the superconducting bulk 130, even without an external magnet.

When organizing the procedure that replaces the conventional RMB method, the reverse magnetization coil is replaced with the superconducting bulk having a cylindrical shape or the like, the magnetic field is trapped by performing the field cooling (in the state of applying an external magnetic field), and the external magnetic field is removed, thereby generating the trapped magnetic field in superconducting bulk. Thus, the conventional RMB method may be replaced with a new technique for performing the reverse magnetization of the DC reactor, using the superconducting bulk.

FIG. 8 is a diagram illustrating a procedure of a reverse magnetization method using the superconducting bulk according to one embodiment of the present invention.

Referring to FIG. 8, the reverse magnetization method using the superconducting bulk according to one embodiment of the present invention is a new reverse magnetization method using a superconducting bulk in which the DC reactor coil 120 is located on the primary side of the iron-core 110, and the superconducting bulk 120 is located on the secondary side of the iron-core 110.

Specifically, the reverse magnetization method using the superconducting bulk supplies (S110) the current to the DC reactor coil 120 located on the primary side of the iron-core 110, cools (S20) the superconducting bulk 130 located on the secondary side of the iron-core 110, and turning the current OFF (S30) to trap (S40) the magnetic field in the superconducting bulk 130. Thus, by performing the field cooling, while applying a DC current to the DC reactor coil 120, the field trap can be performed in the superconducting bulk 130, even without an external magnet.

Here, when cooling (S20) the superconducting bulk 130, although the liquid nitrogen may be used as a refrigerant, it is a matter of course that the present invention is not limited thereto. Also, when cooling (S20) the superconducting bulk 130, it is desirable to cool the superconducting bulk of cylindrical shape, it is also possible to achieve the shape of the superconducting bulk 130 in some other shapes, as described above.

In the case of a large capacity coil that requires the large inductance, since a considerable magnitude of the current also needs to be applied to the reverse magnetization coil (RMB coil), a power supply is required. However, since the reverse magnetization method using the superconducting bulk according to one embodiment of the present invention does not require a circuit for applying the current, it is possible to reduce the power consumption and the cost burden.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A reverse magnetization structure of a DC reactor comprising:
an iron-core;
a DC reactor coil located on a primary side of the iron-core; and
a superconducting bulk located on a secondary side of the iron-core.

2. The reverse magnetization structure of the DC reactor of claim 1, wherein the superconducting bulk has a cylindrical shape.

3. The reverse magnetization structure of the DC reactor of claim 1, further comprising:
a cooler that cools the superconducting bulk.

4. The reverse magnetization structure of the DC reactor of claim 3, wherein the cooler uses liquid nitrogen as a refrigerant.

5. The reverse magnetization structure of the DC reactor of claim 1, further comprising:
a power supply that supplies current to the DC reactor coil.

6. A reverse magnetization method using a superconducting bulk in which a DC reactor coil is located on a primary side of an iron-core, and a superconducting bulk is located on a secondary side of the iron-core, the method comprising:
supplying the current to the DC reactor coil;
cooling the superconducting bulk; and
turning the current OFF to trap the magnetic field in the superconducting bulk.

7. The method of claim 6, wherein the cooling further comprises using liquid nitrogen as a refrigerant.

8. The method of claim 6, wherein the cooling further comprises cooling the cylindrical superconducting bulk.
